(19) United States
(12) Patent Application Publication
(10) Pub. No.: US 2026/0252389 A1
(43) Pub. Date: Aug. 27, 2026

(54) ARTIFICIAL INTELLIGENCE AGENT EFFICIENCY BY IMPROVED GPU RESOURCE CONCURRENCY AND MEMORY UTILIZATION

(71) Applicant: Aible Inc., Pleasanton, CA (US)

(72) Inventors: Arijit Sengupta, Las Vegas, NV (US); Jonathan Wray, Lago Vista, TX (US); Joseph Veltkamp, Corte Madera, CA (US); Frank Taylor, San Francisco, CA (US); Aashish Sairam Pitchai, San Francisco, CA (US); Richard Cooke, Hayward, CA (US)

(21) Appl. No.: 19/546,179

(22) Filed: Feb. 20, 2026

Related U.S. Application Data
(60) Provisional application No. 63/763,815, filed on Feb. 26, 2025.

(51) Int. Cl. G06F 9/50

(52) U.S. Cl. CPC G06F 9/5011

(57) ABSTRACT

Improvements for the utilization of graphics processing units for processing artificial intelligence tasks by an AI agent are described. A device may evaluate a plurality of graphic processing units in a resource pool to determine a concurrency metric for each graphic processing unit in the resource pool, receive data characterizing a task for an AI-based process configured to be executed by the resource pool at an AI-agent, receive data characterizing user preferences, rout the task for the AI-based process to at least one graphic processing unit of the plurality of graphic processing units in the resource pool based on the determined concurrency metric and the data characterizing preferences.

### CROSS REFERENCE TO RELATED APPLICATIONS

This application claims priority to U.S. Provisional Patent Application No. 63/763,815, filed February 26, 2025, and entitled “Artificial Intelligence Agent Efficiency by Improved GPU Resource Concurrency and Memory Utilization,” the entire disclosures of this application are incorporated herein by reference.

### TECHNICAL FIELD

The subject matter described herein relates to improved efficiency of artificial intelligence agent(s).

### BACKGROUND

Artificial intelligence (AI) models require extensive computational processing resources and memory. Graphics processing units are often used to make inferences from AI models or to train AI models. AI tasks (e.g., inferences or training by an AI model) may be executed on a GPU by an AI agent, which can be a system or program that is capable of autonomously performing tasks on behalf of another user or another system. AI agents can send AI-model related tasks (such as for inferences or training) to GPUs. However, in order to improve efficiency, GPUs may be sent AI-model related tasks separately in a way that they can be run concurrently in order to improve overall production and reduce average computation costs. Concurrency may refer to the batching of multiple user or systems requests (e.g., AI tasks) on a single GPU such that they are executed at the same time. However, concurrently run AI tasks may experience performance degradation for the AI-related tasks run on the GPU at the same time. Additionally, it may be difficult to determine efficient concurrency settings for an AI agent as it may vary according to the data passed to the AI agent, resources available at the GPU and the like. Additionally, it may be difficult to determine efficient concurrency settings for AI agents as each AI agent may involve one or more different AI-models, each of which can be invoked a number of times in the performance or execution of an AI-task.

### SUMMARY

Aspects of the present disclosure are related to improving efficiency of computer architecture associated with artificial intelligence agent(s).

In some aspects, a method includes the steps of: evaluating a plurality of graphic processing units in a resource pool to determine a concurrency metric for each graphic processing unit in the resource pool; receiving data characterizing a task for an AI-based process configured to be executed by the resource pool at an AI-agent; receiving data characterizing user preferences; and routing the task for the AI-based process to at least one graphic processing unit of the plurality of graphic processing units in the resource pool based on the determined concurrency metric and the data characterizing preferences.

One or more of the following features can be included in any feasible combination. For example, the resource pool may include computation units configured to be collectively managed to execute AI-related workloads by an allocator configured to dynamically select one or more computation units for task execution. The task may include an AI-related workload selected from an inference task, a training task, a fine-tuning task, or a multi-model agentic workflow, the task being characterized by one or more attributes including prompt length, input token volume, output token volume, model type, model size, execution time, or memory consumption.

In some aspects, evaluating the plurality of graphic processing units includes: monitoring data associated with previously executed tasks, the data including at least one of: task type, prompt length, GPU memory usage, GPU availability, input token volume, output token volume, execution time, or end-to-end latency; executing tasks at varying concurrency levels on each graphic processing unit of the resource pool and monitoring resource consumption and output timing during execution; generating, for each graphic processing unit, a cost–latency metric that relates cost-per-request and end-to-end latency to concurrency level; identifying an operating region in which cost-per-request is reduced while end-to-end latency remains within a latency band; determining task-compatibility groupings by analyzing token-level characteristics, model type or size, memory footprint, and whether tasks involve inference, fine-tuning, or training; and continuously updating the concurrency metric responsive to changes in GPU workload or task mix.

In some aspects, the concurrency metric includes a cost-per-request associated with executing a plurality of tasks simultaneously on a given graphic processing unit. In some aspects, the concurrency metric includes an end-to-end latency measurement generated from monitoring completion times of concurrently executed tasks. In some aspects, evaluating the plurality of graphic processing units includes determining an optimal operating point at which cost-per-request is minimized while end-to-end latency remains below a threshold. The end-to-end latency may be indicative of a total time taken for a task to be completed from when it is submitted to the AI-agent to when a final output is provided to a user.

In some aspects, receiving data characterizing user preferences includes receiving, via a user interface slider or selector, a latency-to-cost preference ratio. In some aspects, routing the task includes selecting a graphic processing unit having a concurrency metric matching the user preferences within a predetermined tolerance. In some aspects, the data characterizing the task includes a prompt length associated with an inference request. In some aspects, the data characterizing the task identifies a model size or parameter count corresponding to an model invoked by the AI-agent. In some aspects, routing the task includes batching the task with one or more additional tasks to form a concurrency group having an aggregate resource requirement below a GPU capacity threshold. In some aspects, the method includes updating the concurrency metric responsive to detecting a change in GPU workload or task mix. In some aspects, a task mix includes a collection of concurrently pending or executing tasks characterized by differing task types, prompt lengths, input token volumes, output token volumes, model types, model sizes, memory footprints, or execution times.

In some aspects, determining the concurrency metric includes implementing a machine learning model configured to predict performance degradation characteristics at increased concurrency levels.

In some aspects, a method includes the steps of receiving data characterizing a task for an AI-based process at an AI-agent, wherein the task is configured to be performed by a resource pool comprising one or more graphic processing units; determining subset of the resource pool to perform the received task based on a cost-latency relationship and utility function; and instructing the determined subset of the resource pool to perform the received task.

One or more of the following features can be included in any feasible combination. A process may include receiving data characterizing a task for an AI-based process at an AI-agent, where the task is configured to be performed by a resource pool including one or more graphic processing units; and determining subset of the resource pool to perform the received task based on a cost-latency relationship and utility function; and instructing the determined subset of the resource pool to perform the received task. In some aspects, the utility function includes a weighted combination of cost, latency, throughput, and output quality, and determining the subset of the resource pool includes selecting one or more graphic processing units whose expected operating point best satisfies the weighted combination. In some aspects, the method further includes continuously updating a cost-latency relationship for at least a portion of the resource pool based on performance data captured during execution of previously allocated tasks, the performance data including at least execution time, end-to-end latency, memory usage, and concurrency level. In some aspects, the method includes instructing the determined subset includes batching the received task with one or more additional tasks to form a concurrency group whose aggregate resource requirement is below a capacity threshold for a selected graphic processing unit. In some aspects, determining the subset includes preferentially allocating tasks that invoke a shared base model to a common graphic processing unit while loading different fine-tuned adapter layers for respective tasks. In some aspects, determining the subset includes partitioning a single graphic processing unit into a plurality of logical partitions and allocating the task to a selected partition based at least in part on prompt length, input token volume, or output token volume associated with the task.

In some aspects, the techniques described herein relate to a method, wherein instructing the determined subset includes generating an execution plan specifying, for each selected graphic processing unit, a concurrency level, a memory-allocation policy across models invoked by the task, and a target end-to-end latency band consistent with the utility function.

In some aspects, the techniques described herein relate to a system including: at least one data processor; and memory storing instructions, which when executed by the at least one data processor, cause the at least one data processor to perform operations including: evaluating a plurality of graphic processing units in a resource pool to determine a concurrency metric for each graphic processing unit in the resource pool; receiving data characterizing a task for an AI-based process configured to be executed by the resource pool at an AI-agent; receiving data characterizing user preferences; and routing the task for the AI-based process to at least one graphic processing unit of the plurality of graphic processing units in the resource pool based on the determined concurrency metric and the data characterizing preferences.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, a processor-to-processor interconnect, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system diagram illustrating a platform for improving GPU resource concurrency utilization for AI models;

FIG. 2 is a process flow diagram illustrating a method for improving GPU resource concurrency utilization for AI models;

FIG. 3 is a chart illustrating concurrency in AI models;

FIG. 4 is a chart illustrating cost and end to end latency; and

FIG. 5 illustrates performance testing of various AI agents.

Like reference symbols in the various drawings indicate like elements.

### DETAILED DESCRIPTION

AI agent(s) are systems or programs that are capable of autonomously performing tasks on behalf of another user or another system. The tasks performed by an AI agent may be executed on a graphics processing unit (GPU). Graphics Processing Units (GPUs) may receive AI tasks for training or making inferences from AI agents that are batched to run at the same time (concurrently) even if the AI tasks belong to different users or require different system requests. The underlying tasks that are provided to the GPU may require extensive computational processing resources and memory. The GPUs may be sent AI agent related tasks (such as for inferences or training) separately in a way that they can be run concurrently in order to improve overall production and reduce average computation costs. However, concurrently run AI tasks may experience performance degradation for the AI-related tasks run on the GPU at the same time.

Because AI models and their respective tasks come in different forms with different processing requirements and durations, some concurrently run AI tasks may experience degradation when concurrently executed on a GPU. The impact or performance degradation experienced for an individual AI-task may vary based on the concurrent payload.

AI agents may also involve one or more different AI-models, each of which can be invoked a number of times in the performance or execution of an AI-task. Accordingly, AI agents may have different latencies based on the underlying AI-models that are invoked, how many times the AI-models are invoked, and the like.

Performance degradation may refer to increases in end-to-end latency.

In some implementations built in accordance with the present disclosure, the AI agents can be optimized and account for the performance degradation experienced in part due to the configurations of the GPU machines used to perform tasks for the AI agents. For example, concurrency characteristics for AI-models and their corresponding prompt length can be determined for a plurality of AI-models and GPUs. The AI agent can then be optimized for overall throughput or end-to-end response time.

In some implementations the disclosed systems and methods can generate an execution plan that utilizes a resource pool and AI model settings in order to have improved performance of the AI-agent. For example, the AI agent can model the performance of one or more underlying AI-models that are components of the AI agent. In some implementations the disclosed systems and methods can be used to determine concurrency settings or relative share of resources such as memory to enable optimization of using the underlying AI-models. In some implementations, the disclosed systems and methods can be used to determine the performance of various AI-models for each AI-agent. In this manner, improved or optimal settings for concurrency characteristics per model and prompt length for various AI-models and/or AI-agents can be determined. In some implementations the AI-agent can be optimized or improved for efficiency in providing greater overall throughput (e.g., number of AI-based tasks executed) or reducing end-to-end response lag time (e.g., time from an AI-based task being prompted to executed).

In some implementations, provided is a platform that enables improved concurrent processing at a resource pool including one or more graphic processing units (GPUs) and the like. A resource pool may include one or more computation units configured to be collectively managed to execute AI-related workloads by an allocator configured to dynamically select one or more computation units for task execution. The platform may be configured to enable a resource pool to execute multiple tasks simultaneously or concurrently. The platform can interface with various AI models as well as a tasker/allocator that allocates the resources from the resource pool that are available to the AI models. The platform can control multiple jobs and provide the resource pool of GPUs with various requests for processing. The platform can capture metadata and identify optimal payloads for the resource pool to process concurrently. The payloads may include information regarding the type of model, the type of inference tasks, the type of GPU, information regarding the memory and speed requirements, and the like. Payloads may include information regarding the size of the AI model, number of parameters associated with the AI models. In some implementations, non-AI workloads on the GPU such as video processing or networking tasks, and the like may be indicated by the payload. In some implementations, the type of AI input and output as well as the formats for the input and output (e.g., voice, video, text, image) can be included in a payload.

AI tasks may also be executed on a GPU by an AI agent, which can be a system or program that is capable of autonomously performing tasks on behalf of another user or another system. Accordingly, in some implementations a process may continuously evaluate the concurrency characteristics of GPUs in a resource pool that are available to an AI agent. For example, the concurrency characteristics for GPUs in a resource pool may be determined for a specified AI model, prompt length, resource characteristic, and the like. In some implementations, the concurrency characteristics may specify a concurrency value that corresponds to the lowest cost-per-request for an acceptable end-to-end latency time. Concurrency characteristics for the pool of GPUs can be updated continuously, responsive to the completion of a task, on the order of seconds, minutes, hours, daily, and the like. In this manner, for each AI agent, the corresponding concurrency characteristics for a pool of GPU resources can be monitored on a continuous basis such that when the AI agent receives a request for execution of a task it can allocate or deploy it to the most appropriate GPU resource in the pool of resources. By utilizing the GPU resources with the most favorable concurrency characteristics, the AI agent can be optimized to increase overall throughput and reduce end-to-end latency.

A task may refer to any AI-related or compute-related workload that the AI-agent sends to the resource pool for execution. A task can be characterized by input data, a model invocation, and expected outputs, and may vary widely in computational complexity. Tasks include inference tasks (e.g., generating text, analyzing data, running a vision model, producing embeddings), training tasks (e.g., fine-tuning a model with LoRA layers, reinforcement-learning steps, batch training), mixed or agentic workloads (e.g., workflows requiring multiple models (video model + guardrail model + detection model), and non-AI tasks (video processing, networking workloads). Tasks can be further characterized by attributes such as prompt length or input token volume, output token volume, model type or model size, memory footprint, execution time, cost/latency sensitivity (as specified by user preferences), and whether the task is suitable for batching or concurrency grouping.

In some implementations a tasker/allocator can utilize artificial intelligence based techniques to generate a cost-per-request and end-to-end latency relationship and allocate resources from the resource pool in accordance with the generated cost per request and end to end latency relationship. The platform may be configured to collect metadata regarding the requests sent for processing by the resource pool, the timing, resources, and costs expended by the resource pool to execute the request, and the like. The collected metadata can be analyzed using artificial intelligence based techniques to identify an optimal operating point. The optimal operating point can be identified based on the generated cost per request and end-to-end latency relationship from the metadata. For example, in some implementations as the number of concurrent tasks is increased, the cost per request will be reduced until a plateau is reached and the cost per request will decrease minimally even while the end-to-end latency will continue to increase substantially. This pattern is specific to the processor type, model, prompt-length, amount of memory allocated, etc. The collected metadata and information regarding the optimal operation point can be used to generate an execution plan that includes an allocation plan that may indicate a subset of the resource pool to be used for a particular task.

For example, in some implementations, a GPU in the resource pool may be capable of processing an inference task on the order of milliseconds to minutes, while the same GPU is capable of processing a training task on the order of hours. Metadata regarding the amount of time required to complete a task, the particular type of task, and the like can be used to gather information regarding the payloads provided to the GPU and the resulting completion time. Based on the metadata the length of prompt, type of model, training, each GPU of the resource pool may have a different performance. In some implementations a task allocation system can be used to optimally allocate tasks to the GPUs.

In some implementations, a platform may monitor metadata surrounding a task and performance by GPUs for the particular task. The platform may apply a deep learning method or statistical analysis to determine an optimal operating point, or how much concurrency corresponds to a balance of reduced costs and least processing time. As not all GPUs or GPU data centers have the same capabilities, some implementations of the current subject matter can learn, for a given GPU or pool of GPUs, the performance characteristics of the GPU or pool of GPUs, and use this learning when allocating tasks to improve overall data processing performance.

In some implementations, the platform may also adjust the optimal operating points based on a utility function that is input by a user. The utility function may account for a user’s preferences as far as processing time, cost, volume, and quality of responses provided by the GPU and the like.

In some implementations, the identified optimal operating point can be used to generate a tasking/allocation request of the resource pool which may include a specified GPU resource or request an additional resource. The tasking/allocation request may include an allocation plan or execution plan.

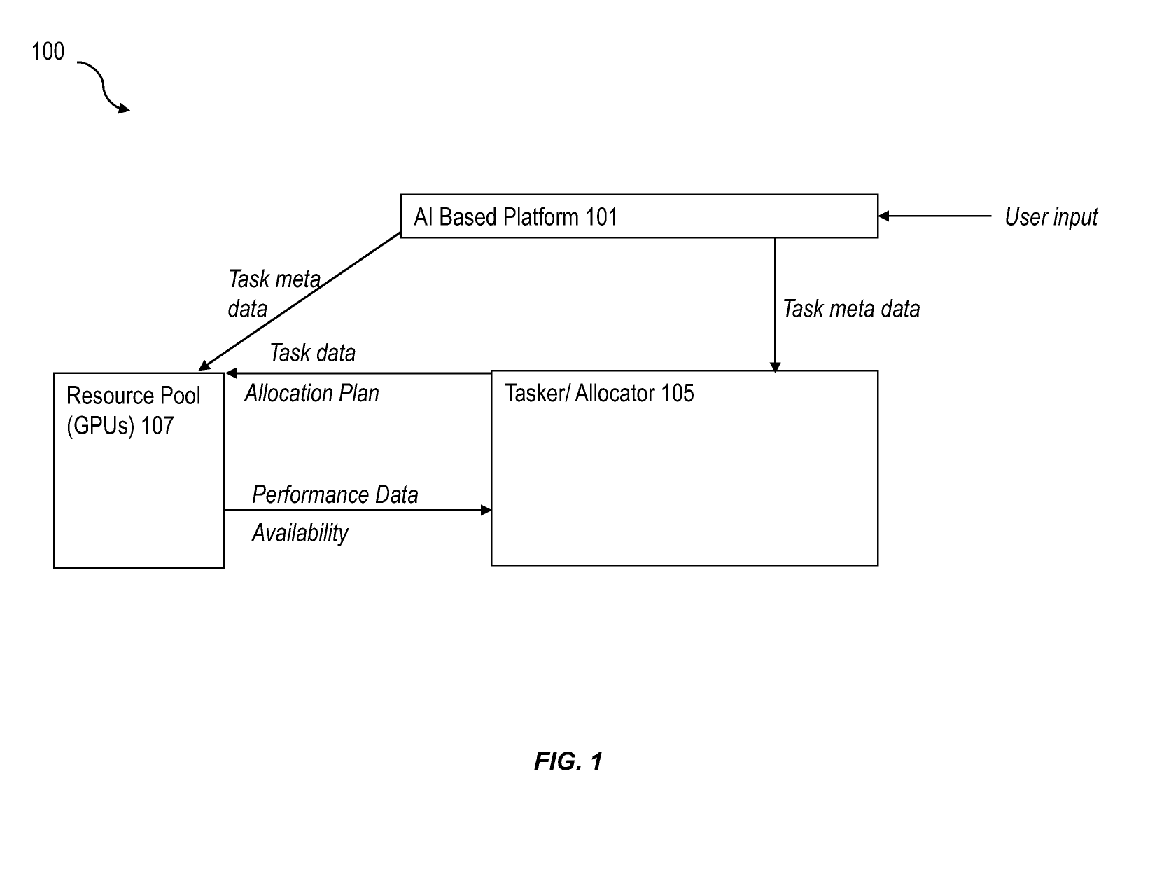

FIG. 1 is a system diagram illustrating a platform for improving GPU resource concurrency utilization for AI models. Concurrency may refer to the ability to execute more than one task at the same time on a single resource such as a GPU. Tasks may be received by a platform from the same user, different users, or the like. As shown in FIG. 1, a platform 101 may receive customer or user input 103. The platform can be connectively coupled to a tasker/allocator 105 that is communicatively coupled to a resource pool 107. The resource pool can include a collection of GPUs capable of performing one or more tasks that are allocated by the tasker/allocator 105. The tasker/allocator 105 can specify the tasks that the resource pool is requested to complete as well as the allocation of tasks and resources. In return, the tasker/allocator 105 may receive information regarding the performance availability of the resource pool and its respective GPUs. The platform 101 can parse user input including cost, response time, and quality needed, meta data and the like, and determine the tasks that need to be performed by the resource pool. In some implementations, the platform 101 can provide identified tasks directly to the resource pool 107. In some implementations, the platform 101 provides identified tasks to the tasker/allocator for allocation to various GPUs in the resource pool.

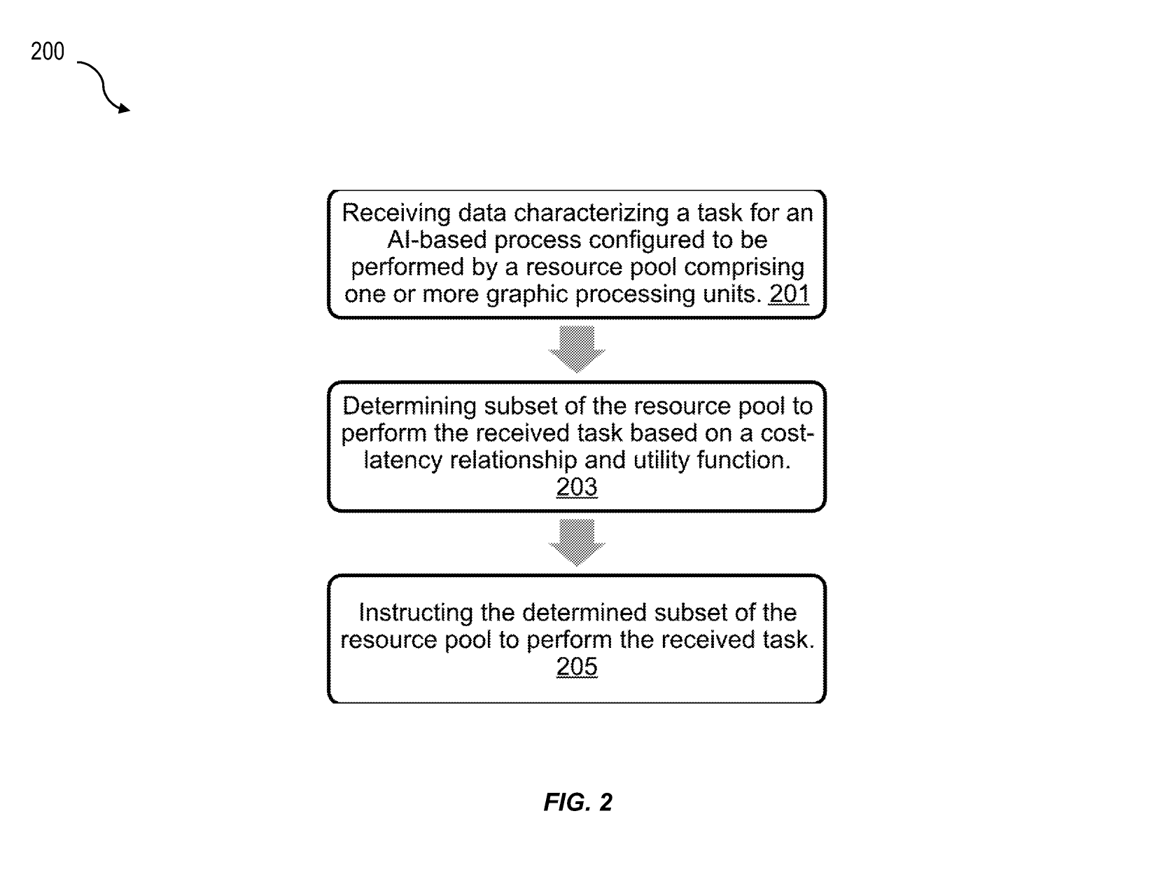

FIG. 2 is a process flow diagram illustrating a method for improving GPU resource concurrency utilization for AI models. As illustrated in FIG. 2, a process 200 can include the steps of receiving data characterizing a task for an AI-based process configured to be performed by a resource pool comprising one or more graphic processing units 201, determining subset of the resource pool to perform the received task based on a cost-latency relationship and utility function 203, and instructing the determined subset of the resource pool to perform the received task 205.

In some implementations, the task allocator can be configured to generate a cost-latency relationship based on characteristic of a subset of one or more GPUs or a pool of GPUs as a function of the type of AI task request. The process for generating a cost-latency relationship can implement a broad learning algorithm that learns and tailors to a given AI platform. In some implementations the cost-latency relationship can be determined by monitoring the GPU performance. Monitoring the GPU performance can include monitoring a GPU’s availability, performance, quality of output, timing of output, resources used, and the like. Monitoring can be performed for a provided task and can include monitoring metadata for the task. Examples of metadata for the task include a task type, prompt length, and the like. Parameters for a utility function can be obtained from the user and indicate the user’s cost, latency, and quality priorities (e.g., a relative or absolute weighting of the importance of cost and the importance of latency for performing a task). Then, using the cost-latency relationship of the resource pool and the user’s indicated cost and latency priority for a given AI task, the best GPU (or GPUs) to allocate to for processing can be determined.

In some examples, if a GPU is set at a concurrency of 4, the GPU may be configured to accommodate workloads of 4 inference tasks, or any combination of inference that is less than or equal to 4 tasks. All of the AI models for training and inference corresponding to the tasks may have different computational requirements. The performance of combinations of dissimilar tasks can be studied to determine an efficient combination and maximize overall productivity by creating sets of optimal tasks from the set of available tasks.

Sets of optimal tasks may be generated using a set of rules and/or a machine learning algorithm. Optimal sets can be assembled from the pool of all tasks. For example, the AI agent may have a pool of tasks including a 30B parameter image model training task, dozens of text based inference tasks, a text based 8B parameter model fine tuning task with 1,000 fine-tuning feedback examples, and a continuous streaming video risk identification task. There are many ways to run these tasks in the pool of tasks. One approach includes using a single GPU logically split into dedicated parts for individual models or switching between models to run all the tasks at high concurrency. Another approach includes splitting the task into two or more GPUs for lower latency. In another approach, multiple GPUs can be used with each receiving a different subset of the pool of tasks. Each subset of the pool of tasks can be optimized for the specific GPU that it is routed to. For example, overall performance may be maximized if heavy processing tasks are grouped together in a single subset. Accordingly, the 30B parameter image model training with the continuous video risk identification can be placed in the same subset. At the same time, the lighter fine-tuning and inference tasks can be run concurrently on another GPU. Alternatively, the optimal mix can be one heavy processing task per GPU with the remaining GPU using concurrency to execute the smaller inference and training tasks.

For example, in some implementations the GPU(s) may be configured to execute AI-workloads such as inference or training related tasks. However, it is envisioned that the GPUs can run other non-AI tasks as well.

In some implementations, in addition to user’s cost and latency, concurrency metrics may also include quality. Quality may refer to the quality or degree of excellence of the output produced by the GPU. In some implementations, when inference tasks are given more GPU time to process they tend to return higher quality results. Subjective feedback from users can be collected and quality gains provided by allowing additional compute time in determining concurrency metrics can be considered.

In some implementations, the utility function may account for the resources used for the task. For example, GPUs are typically available on a dollar per GPU hour basis, and so the cost of using a GPU can be measured in a dollar per GPU hour basis. However, there is a cost associated with latency or how long a user has to wait for a response from the GPU. In some implementations, the utility function may optimize producing the highest AI compute output per GPU hour (lowest cost per unit compute) with the minimum overall latency. However, this utility function can shift based on the preferences of the end users and live demand. For example, if an application is for real-time AI voice based customer support, the application may be configured to request minimum latency via user preferences to avoid extended pauses during the conversation. In an example with two GPUs sharing tasks at an optimal utility function. If requests from the real-time AI voice system come in, they may require a new GPU to be allocated with low concurrency as the currently allocated GPUs could result in latency that is not appropriate for the task. Similarly, some tasks may have no time sensitivity. These tasks may be overallocated to one of the two GPUs increasing latency and thus pushing it slightly past the optimal utility function as this may be more cost effective than provisioning a new GPU and redistributing the tasks at lower average concurrency across three GPUs.

In some implementations the concurrency metric can be evaluated on an ongoing basis. Accordingly, the tasker/allocator can be configured to dynamically adjust the number of tasks running on a GPU in the resource pool. For example, the tasker/allocator can increase the number of workloads from 4 to 6 on a single GPU as new workloads are received by the tasker/allocator.

In some implementations, a tasker/allocator may receive AI-tasks (or workloads) or non-AI tasks/workloads from a plurality of AI models and/or AI agents.

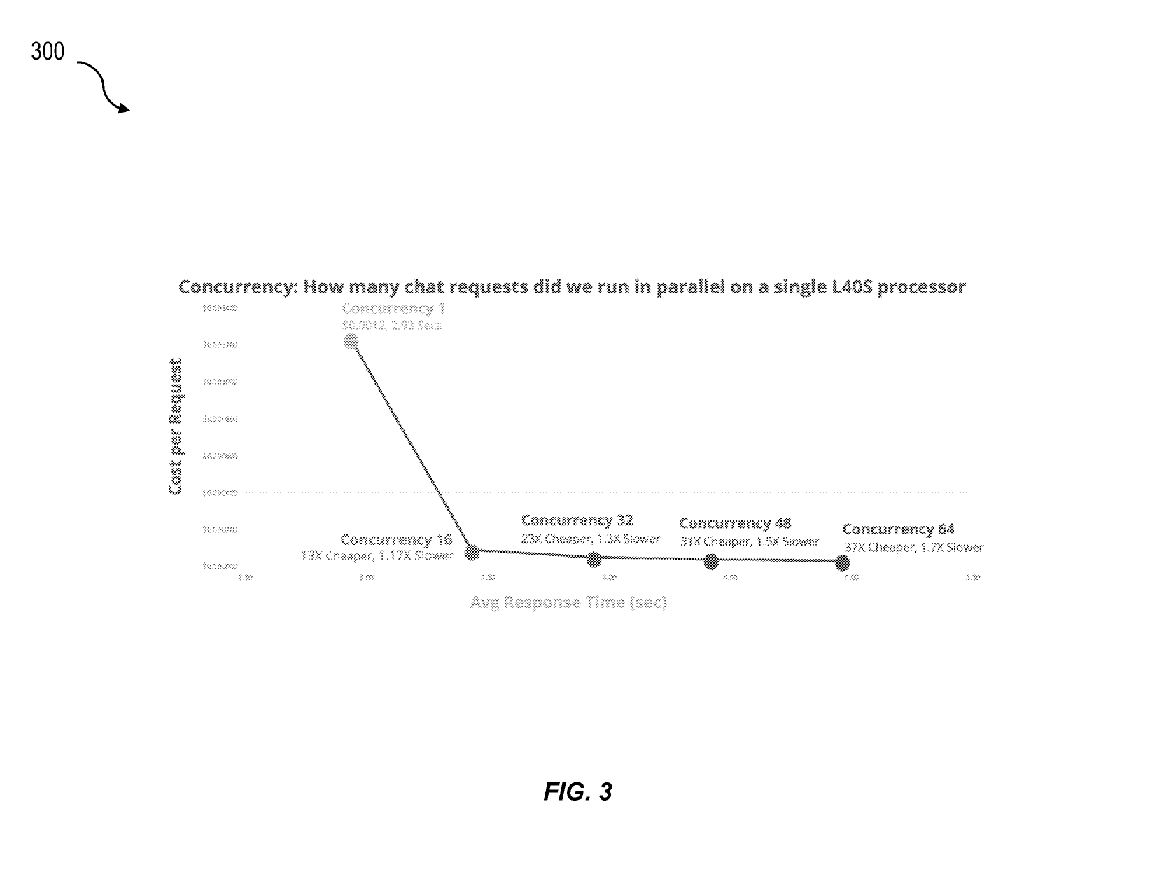

FIG. 3 illustrates the cost versus latency tradeoff characteristics of a single L40S processor that is executing differing numbers of chat request in parallel. For example, as illustrated in FIG. 3, chat requests to an AI-chat bot were run in parallel on a single GPU processor. The cost per request decreased significantly, as more processes were run concurrently. However, the average response time (seconds) also increased.

The concurrency pattern or change in the cost per request as the number of concurrent processes are run may also vary by the “prompt length” or the amount of information a model is provided at run time. Long prompts with a higher “prompt length” generally require more computational resources (time, processing power, memory) as there is more information to process. For example, a request for an AI model or agent to rephase this paragraph into three bullet points will require less computational resources than a request for the AI to review and summarize 5,000 online customer reviews into a two page overview.

As illustrated in FIG. 3, at very high concurrency rates (when too many AI tasks are run at the same time) there is limited to no additional cost benefit or resource efficiency gained, while the average response time continues to increase.

In some implementations, the GPU may also need to run multiple models at the same time. This is especially true for agentic use cases where an end-to-end process may involve a video model, a detection model, a guardrail model, and the like. The more memory a model receives the faster it can run. Given the total amount of memory available is limited, the proportional distribution of memory or computational resources across the models determines their relative speed.

The AI-related tasks may also include a user’s own preferences. These task preferences may indicate whether an AI task can be executed at the lowest cost with no speed requirements, at the fastest possible speed with no cost requirements, or some balance of cost and speed requirements. Task preferences can be used to allocate tasks and optimize productivity. Task preferences can also specify time dependency, where time dependent tasks can be given first priority and can be run with little to no concurrency. Similarly, tasks with low time dependency can be delayed in queue to fill out high concurrency sets maximizing concurrency and minimizing cost. Task preferences can be input by a user and interfaces can include a slider, setting a numerical value, categorizing a particular task as high/medium/low, and the like. Task preferences can be organized by various levels such as by entire organizations, individual teams, individual users, and the like. User task preferences can be viewed as a user utility function that indicates user timing and resource constraints. A user may provide their task preferences using a personalized slider, or setting. For example, an AI voice agent may require low latency. By contrast, in another example, AI based batch processes for reporting may not require low latency. Organizations often run daily reports in the overnight hours. Increasingly AI is being used to review the results and provide summarization and context about the results. These reports are often run in the middle of the night and will not be accessed until employees are online in the morning. In these types of analysis, it does not really matter if the AI agent takes five minutes to respond rather than five milliseconds, and so these tasks do not require low latency, and a user may indicate that using their task preferences. A latency-to-cost preference ratio may indicate a way for a user to express how much they care about fast responses (latency) compared to how much they care about minimizing computational cost.

Tasks can be batched and executed in order to optimize an end to end agent for throughput or end-to-end response time or expected accuracy by optimally setting the relative amount of resources given to each model subject to some minimum amount of resources each model needs, setting the concurrency of each model, choosing alternative models such as a smaller model with lower compute requirements instead of a larger one, and the like. Tasks can include AI-based tasks for inferences and/or training. Tasks can also include non-AI tasks.

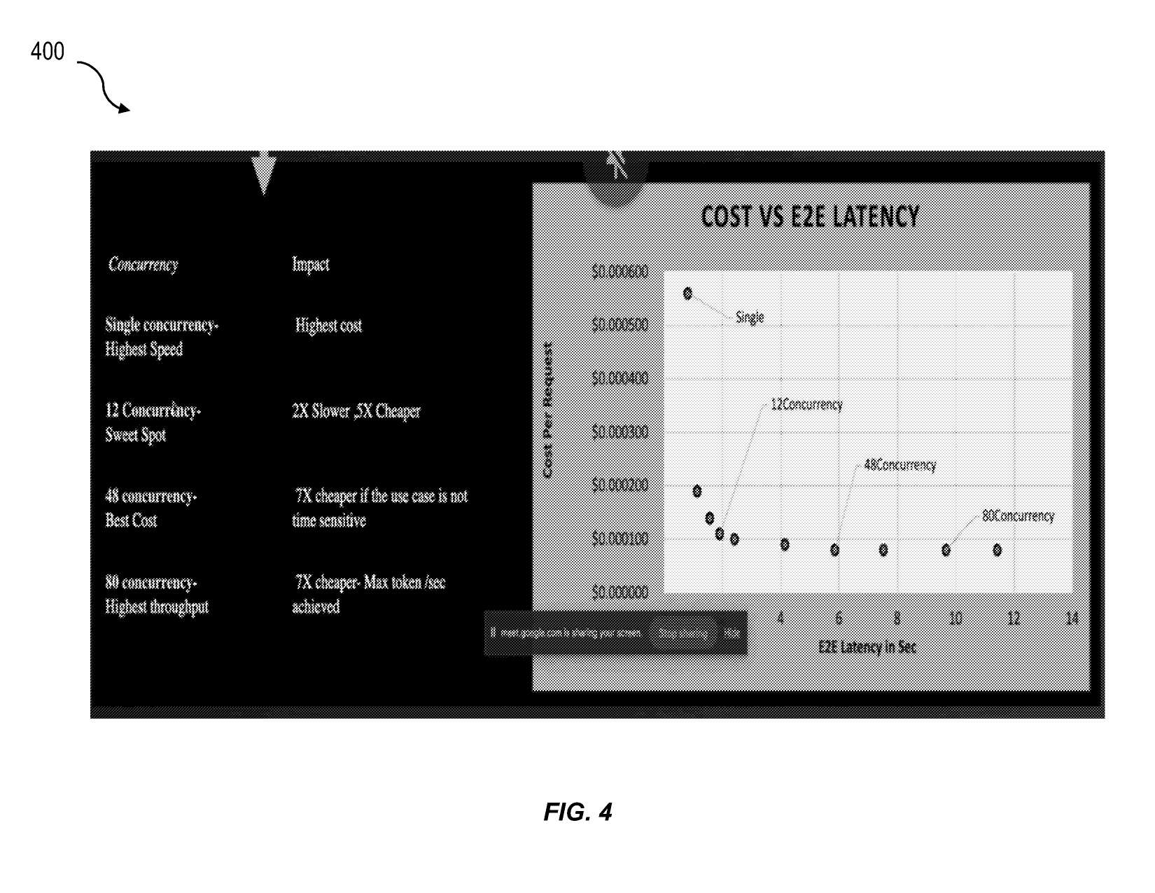

FIG. 4 is a chart illustrating cost and end to end latency. As illustrated, when one task is carried out by a resource pool (i.e., single concurrency), there may be a high cost associated with the request. However, as there is greater concurrency, such as 12 tasks being carried out by the resource pool, the tasks may be completed at lower speeds, but at a lower cost per request. In the illustrated example, when 48 tasks are carried out concurrently, the most efficient cost (lowest cost per request) is achieved. However, as shown in FIG. 4, when 80 tasks are carried out concurrently, the cost per request plateaus while the latency continues to increase, which indicates that there is an optimal balance in cost per request and end-to-end latency. As illustrated in FIG. 4, initially, with increased concurrency there is a reduction in cost per request because you are more fully utilizing the GPU. However, as more tasks are currently executed on the same GPU, the response time or end-to-end latency for each task decreases. In some implementations, cost and end-to-end latency curves can be generated for a plurality of the tasks that are monitored by the platform.

In some implementations, the system identifies payloads or tasks that are compatible for concurrent execution, enabling the platform to determine which combinations of tasks can be executed together to maximize overall throughput. To do so, the system develops a concurrency metric that reflects how the GPU pool behaves under different workloads and varying levels of task concurrency. During operation, the system evaluates a diverse set of task types including, for example and without limitation long-running jobs, short-running jobs, inference workloads, and training workloads. The system may observe how different combinations of such tasks impact GPU utilization and performance. Based on these observations, the system learns which sets of tasks can be co-scheduled on the same GPU or group of GPUs according to a metric or utility function such that throughput of tasks is increased. When tasks are placed into a queue, the system divides them across the available GPUs not only according to hardware capacity but also according to learned compatibility relationships among tasks.

To support optimal allocation, the system further learns the characteristics of the GPU pool and the characteristics of the tasks submitted to it. Each task, often corresponding to a prompt issued by an AI agent, may exhibit distinctive traits relevant to scheduling, such as task type, prompt length, input token volume, output token volume, underlying model type, and whether the task involves fine-tuning or inference. Because different AI agents may produce tasks with significantly different token profiles and computational patterns, the system leverages these task-level attributes to inform scheduling decisions. When a new task is received, the system applies a utility function which may incorporate optimization criteria such as cost, latency, speed, or efficiency and uses the learned performance model to allocate the task to one or more GPUs in a manner consistent with the user’s preferences. Through this combination of learned GPU behavior, task characterization, and user-defined utility optimization, the system intelligently divides and assigns workloads to achieve high performance, efficient resource use, and configurable operating traits.

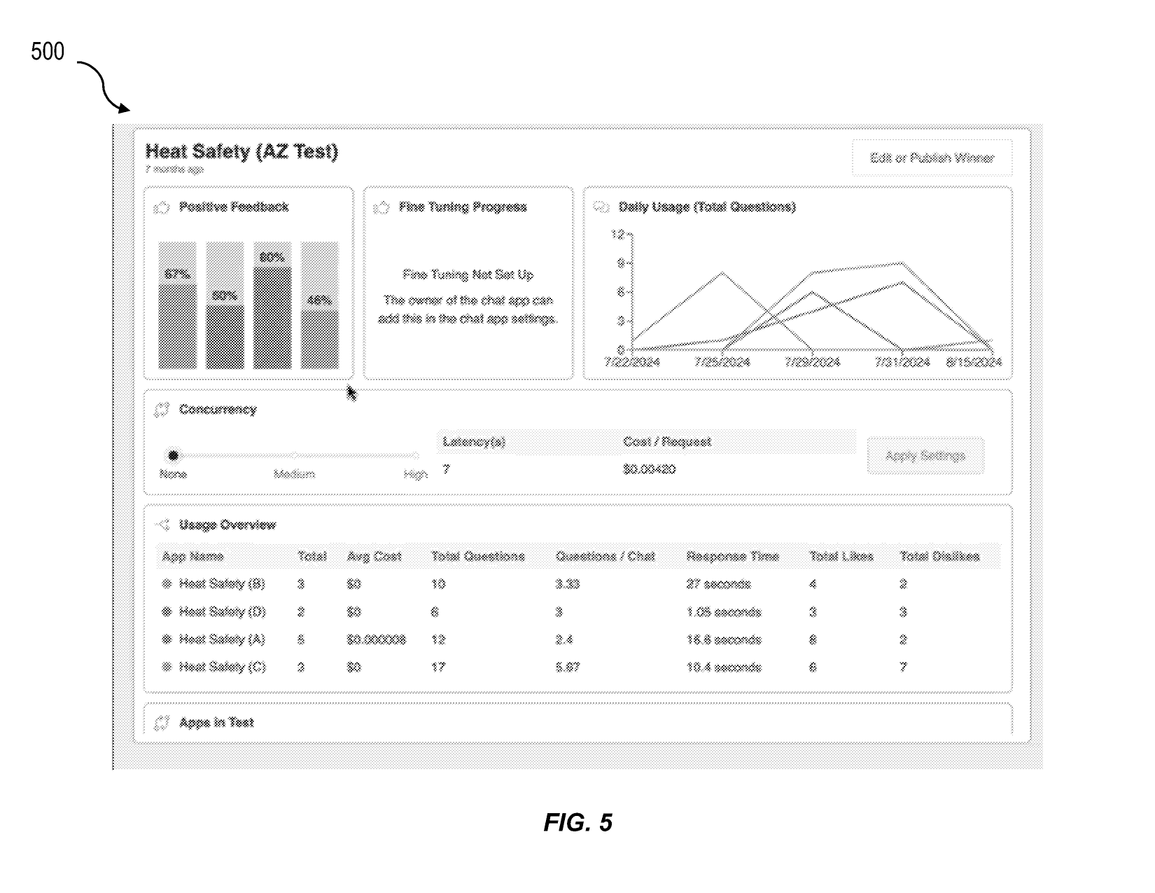

FIG. 5 is an illustration of a process for evaluating the performance of various AI-agents and their respective AI-models and training. As shown in FIG. 5, the performance of one or more AI-agents can be determined. The performance can be impacted by AI-model type, AI-model size, token size, the performance metadata provided to the AI-model, and the like. Performance metrics for multiple variations of each AI-agent can be determined, and then the configurations corresponding to the AI-agent having the best performance (e.g., lowest latency) for resources expended can be selected. In this manner, the claimed systems and methods can be used to efficiently determine configurations for AI-agents which may have various possible configurations.

In some implementations, the platform may analyze the token-level characteristics of tasks to determine their compatibility for concurrent execution. For instance, an agent, such as an NLQ (natural language query) agent, code generating agent (where the code can include python or another coding language) may receive a request such as: “Identify my most profitable customer by analyzing the last 12 months of sales data.” This task may include thousands of input tokens representing tabular data and filtering instructions, while producing a very small output (e.g., a single customer name or a numeric result). Due to the asymmetry between input-heavy and output-light processing, such tasks may be grouped with other tasks having similar token shapes to optimize GPU throughput.

In another example, an analytics-focused AI agent may have a different computational profile. Consider a request such as: “Compare the profitability trends of the top 15 customers and provide visual summaries.” This task may have low input token requirements, because the relevant data is pre-modeled, but higher output token requirements, because the agent may generate a set of charts, narrative comparisons, and textual explanations of relative customer performance. Due to this output-heavy distribution, such tasks may be grouped with other output-heavy inference tasks rather than input-heavy NLQ tasks.

In another example, a document summarization agent may receive long-form text inputs, such as a multi-page report. Here, both the input tokens (full text) and the output tokens (summary) may be relatively large.

In some implementations, the platform can identify that these tasks require significant GPU attention in both directions and may avoid mixing them with workloads that require very low output capacity but large input capacity, or vice versa.

Some implementations may support simultaneous execution of fine-tuning tasks and inference tasks on the same GPU pool. For example, an organization may initiate a fine-tuning task applying low rank adaptation (LoRA) layers to a base model using thousands of feedback examples, while concurrently serving inference requests for agents using the same base model. Because fine-tuning tasks are significantly heavier than inference tasks, the system may schedule them on GPUs with larger available memory, or on GPUs configured for lower concurrency to avoid interference with other ongoing tasks.

In some cases, tasks using compatible models can be co-located on the same GPU. For example, two agents may use the same base model, but different fine-tuned LoRA layers. The system may determine that these tasks can run concurrently because the shared base model reduces memory overhead. By contrast, tasks relying on different base models may be separated because of incompatible memory footprints or different parameter loading requirements.

In some implementations, the system may examine tasks across dimensions such as: task type (e.g., natural language query, analytics, summarization), prompt length (e.g., long documents vs. short queries), input/output asymmetry, model parameter size and the like.

In some implementations, an example classification may include short prompts or small models such as real-time customer queries. Another example classification may include long prompts or large models such as document summarization or multi-table analytics. Yet another example classification may include training-type tasks such as fine-tuning or reinforcement-learning steps. This classification enables the system to assign tasks to GPUs that have demonstrated favorable concurrency metrics for those task profiles.

In one example, a platform receives the following tasks: (1) a small inference request: “Summarize this paragraph into two bullet points,” (2) a long natural language query task: “Analyze thousands of rows of customer transactions and compute the top 5 outliers,” and (3) a visualization task: “Generate comparison charts for customer satisfaction across 12 regions.” The disclosed platform may group tasks (1) and (3) together for one GPU because both tasks require relatively balanced input/output processing, while task (2) may be assigned separately with tasks requiring similarly heavy input processing.

In some implementations, the system operates in two primary phases: a learning phase and an execution (or allocation) phase. In the learning phase, a variety of tasks are executed across a pool of GPUs, either individually or in different concurrent combinations. As these tasks are processed, the system continuously monitors and records the performance characteristics of each GPU and of the task groupings executed on those GPUs.

The monitored performance data can include: execution time for each task or group of tasks, end-to-end latency experienced during processing, resource consumption, such as memory usage, compute load, or throughput, quality of the output, and cost-related indicators, which may be inferred from the above metrics (e.g., GPU time consumed). Using this data, the system generates a profile or model representing the behavior of the GPU pool under various concurrency conditions. This profile captures how different tasks and different combinations of tasks may affect performance as concurrency increases, enabling the system to map performance metrics to specific task characteristics and concurrency levels.

The outcome of the learning phase is therefore a learned performance model that reflects how the GPU pool behaves under varying workloads, which task combinations degrade performance, which concurrency levels are optimal for specific task types, and the relationship between concurrency, latency, and cost.

Once the performance model has been established, it is applied during real-time task allocation or execution phase. When a new task arrives, the system consults the learned model to determine where to allocate the task (i.e., to which GPU or GPUs within the pool), and at what concurrency level the task should be executed. This lookup allows the system to choose the GPU configuration that will provide the most favorable performance given the task’s characteristics.

In addition to the learned model, in some implementations the system incorporates user preferences, which are expressed through a utility function. The utility function may specify the user’s priorities. User priorities may indicate, for example, whether the task should be optimized for low latency, low cost, high throughput, or some balance among these factors. By combining the learned performance profile, and the user-defined utility function, the system makes an informed decision about how to distribute or allocate the task across the available GPUs. This ensures that task allocation is aligned both with the empirically learned behavior of the GPU pool and the specific optimization goals provided by the user.

Additionally, the GPUs may have different characteristics themselves. A GPU may have varying memory resources, or memory allocations. For example, it can be determined whether a particular first GPU chip produces better performance by concurrently running two tasks with a large number of input tokens but relatively few output tokens, along with four small input, medium output token inferencing tasks, and one fine tuning job that's going to be running continuously, or a second GPU chip that has a larger memory and is optimized to run two fine tunings concurrently.

In some implementations, the GPU performance may be shaped by hardware and software configurations including transceivers, firmware, drivers, memory, and the like.

Although a few variations have been described in detail above, other modifications or additions are possible.

The subject matter described herein provides many technical advantages. For example, end users and developers of AI solutions typically do not have the ability to run optimization of GPU resource pools without significant manual optimization testing and configuration. Even then, such optimizations are static and do not change as the request mix changes. Typically, AI solutions are being developed in silos with a mix of internal team and external consultants. Configuring these solutions to work together to optimize the GPU utilization would be very difficult for custom solutions as it would require a high level of collaboration between siloed teams. Additionally, the optimization would only be possible for AI workloads within a particular organization. Within the organization there may not be a large enough workload to run tasks with maximum utilization. By contrast, some implementations of the current subject matter provide a platform that can run optimization securely utilizing payloads from multiple customers which can run more efficiently than any individual organization and having this capability built into the platform provides the optimization to every AI utility or application on the platform.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
evaluating a plurality of graphic processing units in a resource pool to determine a concurrency metric for each graphic processing unit in the resource pool;
receiving data characterizing a task for an AI-based process configured to be executed by the resource pool at an AI-agent;
receiving data characterizing user preferences; and
routing the task for the AI-based process to at least one graphic processing unit of the plurality of graphic processing units in the resource pool based on the determined concurrency metric and the data characterizing preferences.

2. The method of claim 1, wherein the resource pool further comprises computation units configured to be collectively managed to execute AI-related workloads by an allocator configured to dynamically select one or more computation units for task execution.

3. The method of claim 1, wherein the task comprises an AI-related workload selected from an inference task, a training task, a fine-tuning task, or a multi-model agentic workflow, the task being characterized by one or more attributes including prompt length, input token volume, output token volume, model type, model size, execution time, or memory consumption.

4. The method of claim 1, wherein evaluating the plurality of graphic processing units comprises:
monitoring data associated with previously executed tasks, the data including at least one of: task type, prompt length, GPU memory usage, GPU availability, input token volume, output token volume, execution time, or end-to-end latency;
executing tasks at varying concurrency levels on each graphic processing unit of the resource pool and monitoring resource consumption and output timing during execution;
generating, for each graphic processing unit, a cost–latency metric that relates cost-per-request and end-to-end latency to concurrency level;
identifying an operating region in which cost-per-request is reduced while end-to-end latency remains within a latency band;
determining task-compatibility groupings by analyzing token-level characteristics, model type or size, memory footprint, and whether tasks involve inference, fine-tuning, or training; and
continuously updating the concurrency metric responsive to changes in GPU workload or task mix.

5. The method of claim 1, wherein the concurrency metric comprises a cost-per-request associated with executing a plurality of tasks simultaneously on a given graphic processing unit.

6. The method of claim 1, wherein the concurrency metric comprises an end-to-end latency measurement generated from monitoring completion times of concurrently executed tasks, wherein the end-to-end latency is indicative of a total time taken for a task to be completed from when it is submitted to the AI-agent to when a final output is provided to a user.

7. The method of claim 1, wherein receiving data characterizing user preferences comprises receiving, via a user interface slider or selector, a latency-to-cost preference ratio.

8. The method of claim 1, wherein routing the task comprises selecting a graphic processing unit having a concurrency metric matching the user preferences within a predetermined tolerance.

9. The method of claim 1, wherein the data characterizing the task comprises a prompt length associated with an inference request.

10. The method of claim 1, wherein the data characterizing the task identifies a model size or parameter count corresponding to an model invoked by the AI-agent.

11. The method of claim 1, wherein routing the task comprises batching the task with one or more additional tasks to form a concurrency group having an aggregate resource requirement below a GPU capacity threshold.

12. The method of claim 4, wherein a task mix comprises a collection of concurrently pending or executing tasks characterized by differing task types, prompt lengths, input token volumes, output token volumes, model types, model sizes, memory footprints, or execution times.

13. The method of claim 1, wherein determining the concurrency metric comprises implementing a machine learning model configured to predict performance degradation characteristics at increased concurrency levels.

14. A method comprising:
receiving data characterizing a task for an AI-based process at an AI-agent, wherein the task is configured to be performed by a resource pool comprising one or more graphic processing units;
determining subset of the resource pool to perform the received task based on a cost-latency relationship and utility function; and
instructing the determined subset of the resource pool to perform the received task.

15. The method of claim 14, wherein the utility function comprises a weighted combination of cost, latency, throughput, and output quality, and determining the subset of the resource pool comprises selecting one or more graphic processing units whose expected operating point best satisfies the weighted combination.

16. The method of claim 14, further comprising continuously updating a cost-latency relationship for at least a portion of the resource pool based on performance data captured during execution of previously allocated tasks, the performance data including at least execution time, end-to-end latency, memory usage, and concurrency level; and wherein instructing the determined subset comprises batching the received task with one or more additional tasks to form a concurrency group whose aggregate resource requirement is below a capacity threshold for a selected graphic processing unit.

17. The method of claim 14, wherein determining the subset comprises preferentially allocating tasks that invoke a shared base model to a common graphic processing unit while loading different fine-tuned adapter layers for respective tasks.

18. The method of claim 14, wherein determining the subset comprises partitioning a single graphic processing unit into a plurality of logical partitions and allocating the task to a selected partition based at least in part on prompt length, input token volume, or output token volume associated with the task.

19. The method of claim 14, wherein instructing the determined subset comprises generating an execution plan specifying, for each selected graphic processing unit, a concurrency level, a memory-allocation policy across models invoked by the task, and a target end-to-end latency band consistent with the utility function.

20. A system comprising:
at least one data processor; and
memory storing instructions, which when executed by the at least one data processor, cause the at least one data processor to perform operations comprising:
evaluating a plurality of graphic processing units in a resource pool to determine a concurrency metric for each graphic processing unit in the resource pool;
receiving data characterizing a task for an AI-based process configured to be executed by the resource pool at an AI-agent;
receiving data characterizing user preferences; and
routing the task for the AI-based process to at least one graphic processing unit of the plurality of graphic processing units in the resource pool based on the determined concurrency metric and the data characterizing preferences.
